(19) United States
(12) Patent Application Publication
(10) Pub. No.: US 2008/0030838 A1
(43) Pub. Date: Feb. 7, 2008

(54) Light Phase Modulator

(76) Inventors: Kirsten Moselund, Lausanne (CH); Paolo Dainesi, Lausanne (CH); Mihai Adrian Ionescu, Lausanne (CH)

Correspondence Address: NIXON & VANDERHYE, PC, 901 NORTH GLEBE ROAD, 11TH FLOOR, ARLINGTON, VA, 22203, US

(21) Appl. No.: 10/594,391

(22) PCT Filed: Mar. 29, 2005
(86) PCT No.: PCT/IB05/51049

§ 371 Date: Nov. 8, 2006

(30) Foreign Application Priority Data
Mar. 30, 2004 (CH) PCT/CH2004/000197

(51) Int. Cl. G02F 1/015

(52) U.S. Cl. 359/279

(57) ABSTRACT

The invention relates to a light phase modulator, which is based on a multi-gate transistor.

### FIELD OF THE INVENTION

The invention relates to light phase modulation devices.

### STATE OF THE ART

Double gate (DG), tri-gate (TG) and gate-all-around (GAA) MOSFET (generally called multiple-gate devices) have been proposed, analyzed and validated in the last few years in order to develop new device structures that can answer some of the requirements of the SIA roadmap for nanoelectronics. See for instance the following references:

a) F. Balestra, S. Cristoloveanu, M. Benachir, J. Brini and T. Elewa, “Double-Gate Silicon-on-Insulator Transistor with Volume Inversion: A New Device with Greatly Enhanced Performance”, IEEE Electron Device Letters Vol. EDL-8, No. 9, pp. 410-412, 1987.

b) J. Brini, M. Benachir, G. Ghibaudo and F. Balestra, “Threshold voltage and subthreshold slope of the volume-inversion MOS transistor”, IEEE Proceedings-G, Vol. 138, No. 1, pp. 133-136, 1991.

c) J. P. Colinge, M. H. Gao, A. Romano-Rodriguez, H. Maes, C. Claeys, “Silicon-On-Insulator Gate-All-Around Device”, Technical Digest of International Electron Devices Meeting, IEDM '90, pp. 595-598, December 1990.

d) J. P. Collinge, X. Baie and V. Bayot, “Evidence of Two-Dimensional Carrier Confinement in thin n-Channel SOI Gate-All-Around (GAA) Devices”, IEEE Electron Device Letters, Vol. 15, No. 6, pp. 193-195, 1994.

e) L. Ge and J. G. Fossum, “Analytical Modeling of Quantization and Volume Inversion in Thin Si-Film DG MOSFETs”, IEEE Transactions on Electron Devices, Vol. 49, No. 2, pp. 287-294, 2002.

f) J.-T. Park, J.-P. Colinge, “Multiple-Gate SOI MOSFETs: Device Design Guidelines” IEEE Transactions on Electron Devices, Volume: 49, Issue: 12, pp. 2222-2229, December 2002.

g) K. W. Guarini, P. M. Solomon, Y. Zhang, K. K. Chan, E. C. Jones, G. M. Cohen, A. Krasnoperova, M. Ronay, O. Dokumaci, J. J. Bucchignano, C. Cabral, C. Lavoie, V. Ku, D. C. Boyd, K. S. Petrarca, I. V. Babich, J. Treichler, P. M. Kozlowski, “Triple-Self-Aligned, Planar Double-Gate MOSFETs: Devices and Circuits”, Technical Digest of International of Electron Devices Meeting, IEDM'01, pp. 19.2.1-19.2.4, December 2001.

h) F.-L. Yang, H.-Y. Chen, F.-C. Chen, C.-C. Huang, C.-Y. Chang; H.-K. Chiu; C.-C. Lee, C.-C. Chen, H.-T. Huang, C.-J. Chen; H.-J. Tao, Y.-C. Yeo; M.-S. Liang, C. Hu, “25 nm CMOS Omega FETs”, Digest of International Electron Devices Meeting, IEDM '02, pp. 255-258, December 2002.

The concept of multiple-gate MOS devices is to have a thin Si film between two or three gate oxide layers (for the case of the DG and TG respectively), or to have a thin Si core completely wrapped by the gate oxide (for the case of the GAA, which, if scaled, is in fact a transistor based on a nanowire). For thin Si films quantum effects could become relevant, changing dramatically the device performances. In the subthreshold region, in fact, the film is completely depleted, and in the weak-to-strong inversion regime, if sufficiently thin, the Si film/core becomes inverted (volume inversion region). The result is that the whole film volume becomes the conducting channel, being not confined at the interfaces, thus reducing the scattering and providing the device with improved carrier mobility and transconductance. Other advantages are: better control of short channel effects, near ideal subthreshold slope, low subthreshold capacitance, and better scalability compared with conventional MOSFET, just to cite the most important ones.

Light phase modulation in Silicon can be performed by thermal heating, or by variation of free charges. The first one is a slow phenomenon and cannot be useful for state of the art applications like fast switching and optical clock distribution. The injection of free charges is a much faster physical effect, but the best reported results to date are limited in the 20 MHz range, which is still to slow.

Another improvement has been recently shown in a capacitive device (see e.g. U.S. Pat. No. 6,269,199, U.S. Pat. No. 6,480,641 or U.S. Pat. No. 6,323,985), in which, recombination due to charge current flow is absent and hence the modulation frequency can reach the GHz range; on the other hand the very small effective area where the modulation is performed make its efficiency very small.

Other state of the art references are listed below:

i) C. K. Tang and G. T. Reed, “Highly efficient optical phase modulator in SOI waveguides”, Electron. Lett. Vol. 31, pp. 451-452, 1995.

j) P. Dainesi, A. Küng, M. Chabloz, A. Lagos, Ph. Flüickiger, A. Ionescu, P. Fazan, M. Declerq, Ph. Renaud and Ph. Robert, “CMOS Compatible Fully Intetgrated Mach-Zehnder Interferometer in SOI Technology”, IEEE Photonics Technology Letters, Vol. 12, No. 6, pp. 660-662, 2000.

k) A. Liu, R. Jones, L. Liao D. Samara-Rubio, D. Rubin, O. Cohen, R. Nicolaescu and M. Paniccia, “A High-speed silicon optical modulator based on a metal-oxide-semiconductor capacitor”, Nature, Vol. 427, pp. 615-618, 12 Feb. 2004.

Concerning optoelectronics on Silicon, the trend today, is for scaling waveguide dimensions into the micron and even submicron region. Despite the inevitable difficulty in injecting light in submicron waveguides (also called photonic wires), the high index contrast of such structures will provide high field confinement and, consequently, the possibility to access extreme bending (μm radii). Very compact structures are one key element for optical clock distribution but to address such specific application very fast light modulation and light detectors are required.

### SUMMARY OF THE INVENTION

Our invention addresses exactly the previous cited point. It offers an extremely compact (ultra-scaled) and intrinsically very fast phase modulator device easily co-integrable with CMOS electronics.

To this effect the invention concerns a light phase modulator which is characterized by the fact that it is based on a multi-gate transistor.

The multiple gate (MG) transistor is in fact a photonic (nano)wire in which light can propagate with moderate losses and be phase shifted when free charges are injected. The optimized overlap between the optical field and the free charges together with the effects generated by the thin film and the MG structure create the conditions for high efficient and fast modulation.

### DETAILED DESCRIPTION OF THE INVENTION

An embodiment of the invention is presented below in the form of a light phase modulator based on the GAA (Gate All Around) architecture. This embodiment is illustrated by the following figures:

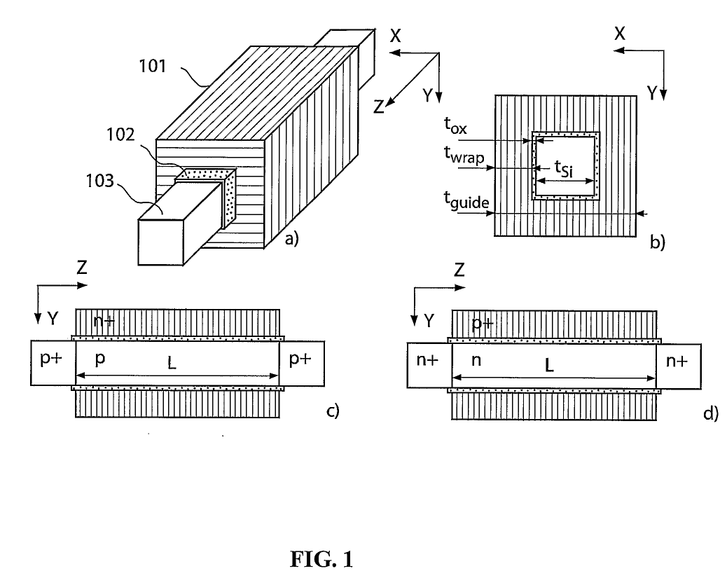

FIG. 1 is a schematic view of a gate-all-around transistor according to the invention. a) 3D fly's eye view; b) Cross section; c) and d) lateral cross sections showing possible doping configuration.

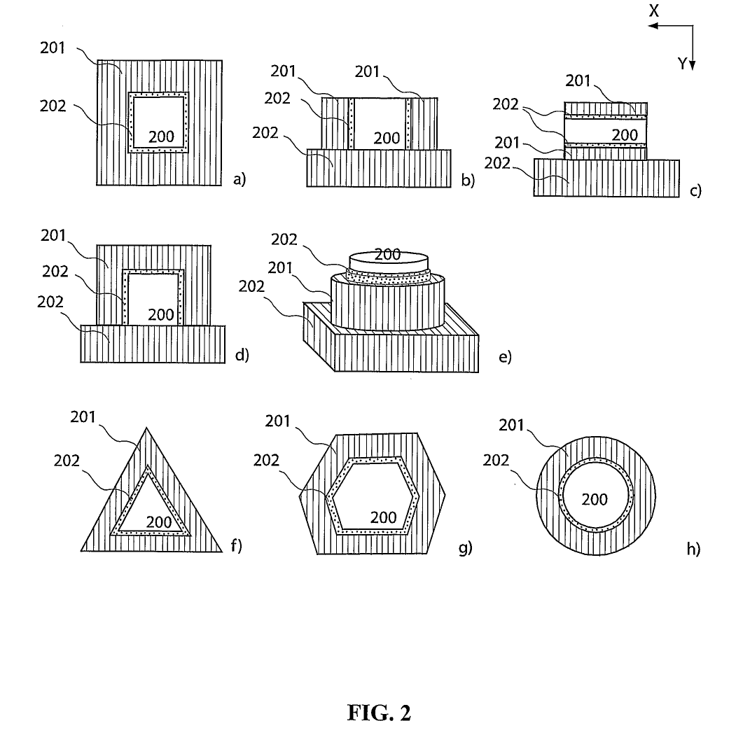

FIG. 2 shows different possible architectures of the invention. a) GAA transistor; b) Side wall transistor; c) Double gate transistor; d) Tri-gate transistor; e) Vertical GAA transistor; f) Triangular GAA; g) Polygonal GAA; h) Ovoid GAA.

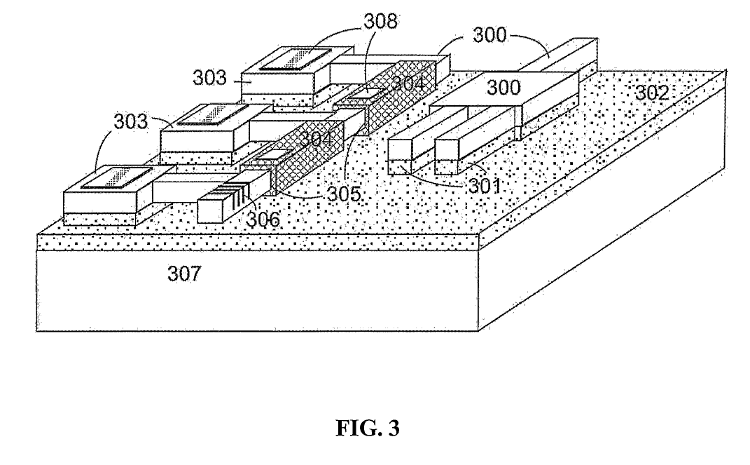

FIG. 3 shows an example of the invention when developed in the three-gate configuration.

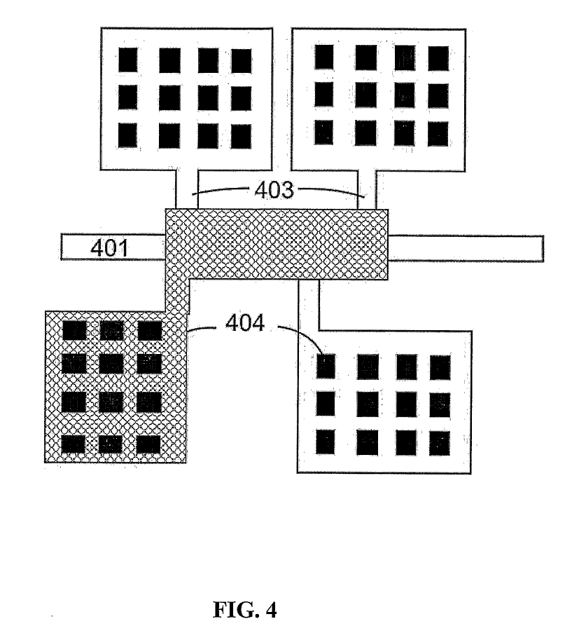

FIG. 4 shows an example of a final mask layout for the fabrication of the invention shown in FIG. 3.

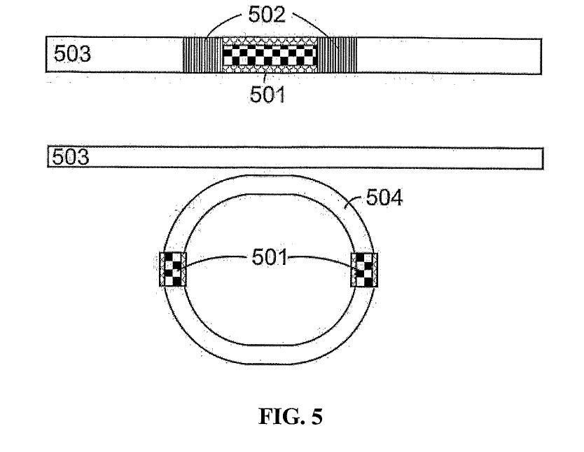

FIG. 5 shows an example of use of the invention in the cavity of a resonant optical structure to form an intensity modulator.

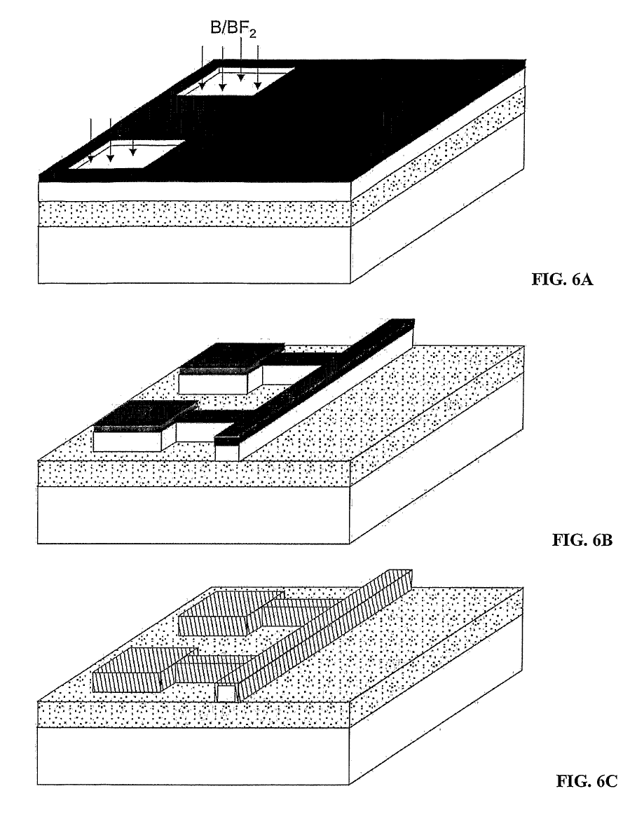

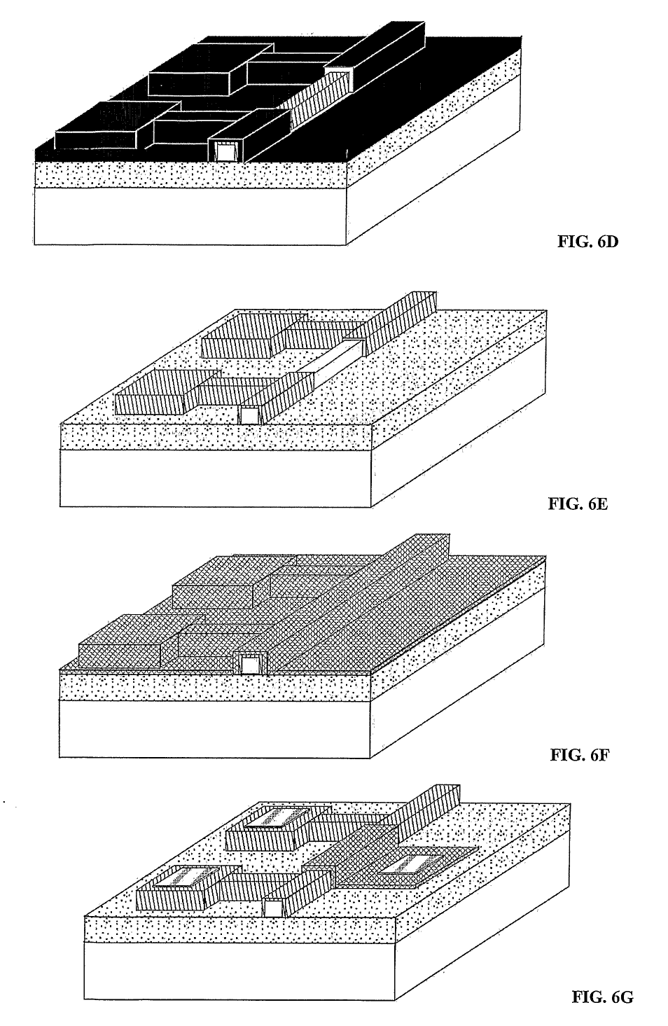

FIG. 6 illustrates a process which can be used for a tri-gate implementation according to the invention.

The following numerical references are used in the figures:
101: Conductive wrapping
102: Gate dielectric
103: Silicon core
200: Silicon core
201: Conductor
202: Insulator
300: Silicon layer
301: First dielectric
302: Second dielectric (might be identical to the first dielectric)
303: Heavily doped implants—hole/electron source
304: Conductive wrapping
305: Gate dielectric
306: Bragg grating mirror
307: Substrate
308: Contact
401: Silicon waveguiding layer
402: Conductive wrapping
403: Heavily doped implants—hole/electron source
404: Contact
501: GAA modulator
502: Bragg grating mirror
503: Silicon layer
504: Silicon ring resonator

FIG. 1a) shows a crystalline Si core which is wrapped in a SiO₂ gate oxide and in a conductive material as gate to form a MOSFET transistor with the gate completely wrapping the silicon photonic wire channel. FIG. 1b) shows the cross section of this device with a typical possible embodiment of the device. Any combination of thicknesses of the three materials giving t_{guide}<1 μm is to be considered a possible optional embodiment of the invention. FIG. 1c) and FIG. 1d), show possible doping conditions of the device. Connecting both p+(n+) regions to ground and giving a bias voltage V_{g} on the n+(p+) region (FIGS. 1c and 1d), the structure is in a capacitive configuration resulting in very high frequency operation together with very low power consumption and negligible parasitic heating effects. In a possible embodiment of the device the conductive wrapping can be doped polycrystalline silicon.

Different architectures are possible in the fabrication of a multi-gate transistor for light phase modulation. FIG. 2 shows the cross sections of some of the most useful possible architectures schemes. FIG. 2a) is a GAA transistor configuration similar to the one described in detail in FIG. 1. FIG. 2b) is a side wall transistor configuration and FIG. 2c) is a double gate (DG) configuration. FIG. 2d) is a tri-gate (or π-gate) configuration while FIG. 2e) is a vertical GAA structure. FIG. 2f) shows the cross section of a possible triangular shaped GAA transistor, FIG. 2g) shows a possible polygonal shaped GAA transistor and FIG. 2h) shows a possible round or oval configuration. All those configurations are to be considered possible embodiments of the invention and also two or more combinations of those are to be considered possible embodiments of the invention (for example a triangular double gate or a rhomboidal tri-gate and so on).

In an example of the invention the transistor can be manufactured in a tri-gate configuration with the following process flow. FIG. 3 shows the a possible final sketch of the invention using a SOI wafer with 1 μm thick buried oxide and 0.34 μm thick silicon device layer, p-type doping are about 5×10¹⁴−10¹⁵.

In FIG. 4 a possible mask layout for the realization of the invention in the form represented in FIG. 3 is presented.

In order to create an intensity modulator the phase modulator must be placed in a resonant structure, either by etching Bragg gratings at either end, which could for example be done by a FIB at the end of processing, or by including an additional e-beam step. Alternatively, the modulator can be placed in the ring, of a ring resonator as illustrated in FIG. 5.

FIG. 6 illustrates a process which can be used for a tri-gate implementation according to the invention. For simplicity, only the fabrication of the phase modulator and a possible p⁺-connection to the core are represented. In fact, at least two source/drain connections are required as shown in the figures, and the final modulator might consist of several series-connected modules.

The process is defined by the following steps:

### FIG. 6A

1. Protective oxide layer at surface

2. Photolithography.

3. P+-implantation of the “source” and “drain” regions. 10²¹ at surface, 10¹⁹ in depth

4. Thermal activation of dopants.

5. Removal of resist.

### FIG. 6B

1. Deposition of hard mask

2. Photolithography.

3. Dry etching of hard mask.

4. Dry etching of silicon

### FIG. 6C

1. Thermal oxidation of the wafer, in order to reduce roughness after dry etching of the surface.

### FIG. 6D

1. Photolithography—opening of gate region.

2. Wet etch of thermal oxide and LTO mask.

### FIG. 6E

1. Removal of resist.

2. Gate oxide ˜10 nm.

### FIG. 6F

1. Deposition of poly-silicon 50-100 nm.

2. Poly-oxidation or deposition of protecting oxide.

3. Blanket doping of poly silicon

4. Doping ˜10¹⁹.

### FIG. 6G

1. Photolithography.

2. Dry etch of poly.

3. Isolating oxide

4. Photolithography.

5. Metallization.

6. Photolithography—metal lines.

It should be noted that the present invention is not limited to the above cited embodiment.

1. A light phase modulator comprising a conducting part characterized by the fact that it is based on a multi-gate transistor, which if scaled in the submicron dimension is a gated-nanowire modulator.

2. Light phase modulator according to claim 1 characterized by the fact that is obtained from a SOI or a Si bulk.

3. Light phase modulator according to claim 1 forming a gate-all-around architecture.

4. Light phase modulator according to claim 1 characterized by the fact that it has a triangular, a rectangular, a polygonal, or an ovoid shape.

5. Light phase modulator according to claim 1 characterized by the fact that it has a triangular, a rectangular or a polygonal form with rounded corners.

6. Light phase modulator according to claim 1 in which the conductor part is doped polycrystalline Silicon.

7. Light phase modulator according to claim 3 forming a capacitive configuration.

8. Optical resonant cavity comprising a light phase modulator according to claim 1.
